(19) United States
(12) Patent Application Publication
(10) Pub. No.: US 2019/0108470 A1
(43) Pub. Date: Apr. 11, 2019

(54) AUTOMATED ORCHESTRATION OF INCIDENT TRIAGE WORKFLOWS

(71) Applicant: Microsoft Technology Licensing, LLC, Redmond, WA (US)

(72) Inventor: Navendu Jain, Seattle, WA (US)

(21) Appl. No.: 15/729,073

(22) Filed: Oct. 10, 2017

(51) Int. Cl. G06Q 10/06; G06N 99/00

(52) U.S. Cl. CPC G06Q 10/063118; G06N 99/005

(57) ABSTRACT

Methods, systems, and apparatuses are provided for enabling an automated handling of information technology incidents in a computing environment. An incident report relating to an incident in a computing environment is received. Based on the incident report, a feature vector is generated and provided as an input to a machine-learning model that may output one or more suggested actions to respond to the incident. For instance, the machine-learning model may be trained based on previous actions performed by a user in response to previous incident reports. A user interface is provided allowing a user to select one or more of the suggested actions. In response to the user's selection, the selected actions may be executed automatically. By orchestrating a set of actions to execute automatically, incident reports may be addressed in a timely and efficient manner.

### BACKGROUND

Incident management systems provide industry professionals with an interface for receiving and responding to incidents. For instance, in an information technology (IT) setting, engineers may receive reports corresponding to a wide range of activities occurring on various systems connected on a cloud-computing network. Responding to each incident in a timely manner is critical since certain incidents may be critical to the operation of one or more systems on the network, and/or impact a customer. When an engineer receives an incident report through an incident management system, the engineer may need to manually perform a set of tasks in responding to the incident. For example, an engineer may need to acknowledge the incident, transfer the incident to another group responsible for responding to the incident, perform steps to mitigate the incident, and/or resolve the incident. However, each individual task requires an engineer to manually perform a separate action on the incident management system.

In some instances, even if the engineer may have previously responded to the same or similar incident, the engineer must repeat the entire set of tasks in responding to the new incident. Given the increasing number of systems connecting to a network, and therefore an increased number of received incident reports, additional manpower may be needed to adequately and efficiently respond to each incident. In addition, where a long series of actions is performed in response to an incident, an engineer may not accurately recall and apply each action previously taken when responding to the same or similar incident in the future, leading to inconsistent and/or erroneous incident resolutions. As the number of incidents continues to increase, the less scalable such an approach becomes.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for enabling an automated handling of information technology incidents in a computing environment. An incident report relating to an incident in a computing environment is received. Based on the incident report, a feature vector is generated and provided as an input to a machine-learning-based model that may output one or more suggested actions to respond to the incident. For instance, the machine-learning-based model may be trained based on previous actions performed by a user in response to previous incident reports. A user interface is provided that allows a user to select at least one of the one or more of the suggested actions. In response to the user's selection, the selected actions may be executed automatically.

In this manner, a machine-learning-based model may automatically orchestrate and execute a set of suggested actions based on the prior actions of a single user or a plurality of users or groups taken in response to the same or similar incident reports, thereby reducing the effort required by a user to manually determine and execute each action individually. Given that the same or similar information technology incident report may be generated numerous times, the automated handling and execution of actions ensures that the incident reports may be addressed in a timely and accurate manner.

Further features and advantages of the invention, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for enabling an automated handling of information technology incidents in a computing environment, according to an example embodiment.

FIG. 2 shows a block diagram of a system for enabling an automated handling of information technology incidents by a server, according to an example embodiment.

FIG. 3 shows a flowchart of a method for enabling an automated handling of information technology incidents, according to an example embodiment.

FIG. 4 shows a block diagram of a computing device comprising an automated incident handler, according to an example embodiment.

FIG. 5 shows a flowchart of a method for extracting a feature vector based on an incident report, according to an example embodiment.

FIG. 6 shows a flowchart of a method for providing a user interface for an automated incident handler on a mobile device, according to an example embodiment.

FIG. 7 shows a flowchart of a method for automatically logging actions from one or more users, according to an example embodiment.

FIG. 8 shows a flowchart of a method for displaying a value indicative of a number of times a suggested action was executed previously, according to an example embodiment.

FIG. 9 shows a flowchart of a method for providing an interface enabling a user to select a subset of actions to execute, according to an example embodiment.

FIG. 10 shows a flowchart of a method for providing an interface displaying an execution progress of the one or more suggested actions, according to an example embodiment.

FIG. 11 shows a flowchart of a method for enabling an automated handling of an information technology incident report based on a determined similarity to previous incident reports, according to an example embodiment.

FIG. 12 is a block diagram of an example mobile device that may be used to implement various embodiments.

FIG. 13 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

I. Introduction

The present specification and accompanying drawings disclose numerous example embodiments. The scope of the present application is not limited to the disclosed embodiments, but also encompasses combinations of the disclosed embodiments, as well as modifications to the disclosed embodiments. References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

II. Example Embodiments.

As noted in the Background section above, incident management systems provide industry professionals with an interface for receiving and responding to incident. For instance, in an information technology (IT) setting, engineers may receive reports corresponding to a wide range of activities occurring on various systems connected on a cloud-computing network. Responding to each incident in a timely manner is critical since certain incidents may be critical to the operation of one or more systems on the network, and/or impact a customer. When an engineer receives such a report through an incident management system, the engineer may need to manually perform a set of tasks in responding to the incident. For example, an engineer may need to acknowledge the incident, transfer the incident to another group responsible for responding to the incident, perform steps to mitigate the incident, and/or resolve the incident. However, each individual task requires an engineer to perform a separate action on the incident management system.

In some instances, even if the engineer or their colleague (e.g., in the same organization) may have previously responded to the same or similar incident, the engineer must repeat the entire set of tasks in responding to the new incident. Given the increasing number of systems connecting to a network, and therefore an increased number of generated incidents, additional manpower may be needed to adequately and efficiently respond to each incident. In addition, where a long series of actions is performed in response to an incident, an engineer may not accurately recall and apply each action when responding to the same or similar incident in the future, leading to inconsistent and/or erroneous incident resolutions. As the number of incidents continues to increase, the less scalable such an approach becomes.

An organization may have thousands of servers and thousands of user computers (e.g., desktops and laptops) connected to their network. The servers may each be a certain type of server such as a load balancing server, a firewall server, a database server, an authentication server, a personnel management server, a web server, a file system server, and so on. In addition, the user computers may each be a certain type such as a management computer, a technical support computer, a developer computer, a secretarial computer, and so on. Each server and user computer may have various applications installed that are needed to support the function of the computer. Incident management systems may continuously and automatically monitor any of these servers and/or computers connected to the network for proper operation, and generate an incident report upon detecting a potential issue on one or more devices or the network itself.

For example, an incident management system may generate an incident report for an alert that may be regarded as noise. For instance, noise may include alerts that do not necessitate any changes be implemented in the computing environment. An alert that may be regarded as noise may include, for example, an alert that a central processing unit (CPU) is exceeding a threshold percentage of its processing usage. In such an instance, a user may understand from prior experiences that the incident relating to excessive CPU usage does not require any system changes, as the CPU usage will eventually drop below the threshold. However, in such a scenario, a user may still need to acknowledge the incident or transfer the incident to another team, insert a date/time, mark the incident with a mitigated status, and resolve the incident. Each time the incident management system generates the same report for excessive CPU usage, the user must perform the same steps in responding to the incident.

Embodiments described herein address these issues by implementing an automated incident handler comprising a machine-learning-based model that suggests, to a user, one or more actions to execute to respond to an incident. The machine-learning-based model automatically learns the actions a user takes in response to each generated incident report. When a new incident report is generated, the automated incident handler extracts a feature vector for the incident report. Using the extracted feature vector, the machine-learning-based model suggests one or more actions to execute, based on prior actions taken in response to same feature vector. The automated incident handler may provide an interface by which a user may accept the suggested actions, modify the suggested actions, reject the suggested actions, or select only a subset of actions to execute. Once the user makes the appropriate selection, the automated incident handler automatically executes the actions selected by the user. In this way, the user need not manually determine and execute the series of actions the user has performed in the past for the same incident.

This approach has numerous advantages, including but not limited to: reducing the time to respond to incidents by eliminating the need to perform sequences of time-consuming but mundane steps for responding to incidents. Furthermore, by orchestrating a set of suggested actions to respond to an incident based on learned behavior, the automated incident handler may suggest and apply a consistent set of actions to orchestrate a response to an incident, thereby reducing the need for a user to remember a precise sequence actions manually performed in the past for the same incident and ensuring incidents are addressed accurately. In addition, by orchestrating a set of suggested actions, a user may enable the incident management system to execute an entire sequence of actions with a single user action, such as a click of a mouse or touching a button on a touch screen, thereby improving a user's productivity. Furthermore, the machine-learning-based model may learn a user's behavior across various services and systems, such as those executing outside of the incident management system, in responding to an incident, thereby unifying a workflow across the various services and systems.

Accordingly, embodiments can provide at least the following capabilities pertaining to managing the execution of applications on a device: (1) a mechanism to reduce the time needed to respond to incidents; (2) a mechanism for enabling an automated incident handler through a machine-learning-based model that orchestrates a set of suggested actions; (3) a mechanism for enabling a sequence of actions to be executed automatically through minimal user involvement; and (4) a mechanism to unify workflows across various systems and services in a computing environment.

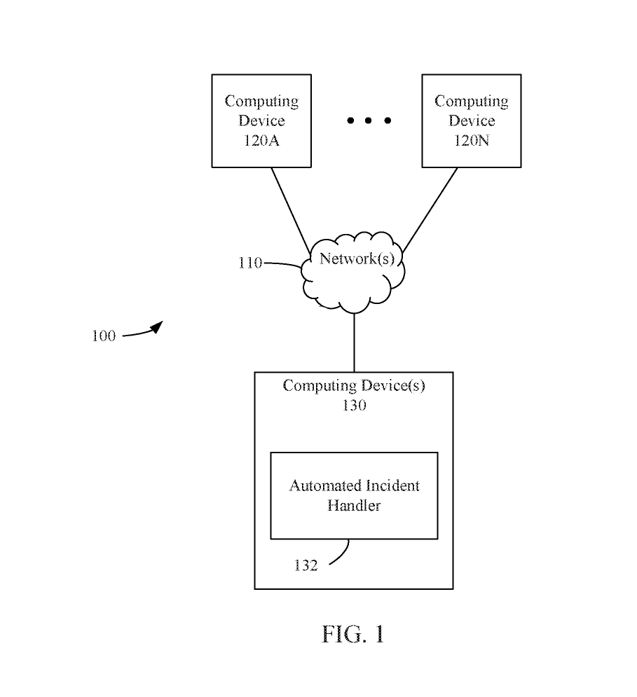

Example embodiments will now be described that are directed to techniques for enabling an automated handling of incidents in a computing environment. For instance, FIG. 1 shows a block diagram of an example automated incident handling system 100 comprising one or more networks 110, computing devices 120A-120N, and one or more computing devices 130. In an embodiment, computing device(s) 130 manage incidents generated with respect to network(s) 110 or any of computing devices 120A-120N. Computing devices 120A-120N and computing device(s) 130 are communicatively coupled via network(s) 110. Though computing devices 120A-120N or computing device(s) 130 may be separate devices, in an embodiment, computing devices 120A-120N or computing device(s) 130 may be included as node(s) or virtual machines in one or more computing devices. Network(s) 110 may comprise one or more networks such as local area networks (LANs), wide area networks (WANs), enterprise networks, the Internet, etc., and may include one or more of wired and/or wireless portions. Computing devices 120A-120N and computing device(s) 130 may communicate with each other via network(s) 110 through a respective network interface. In an embodiment, computing devices 120A-120N and computing device(s) 130 may communicate via one or more application programming interfaces (API). Each of these components will now be described in more detail.

Computing devices 120A-120N may comprise, for example, a network-accessible server infrastructure. In an embodiment, computing devices 120A-120N may form a network-accessible server set, such as a cloud computing server network. For example, each of computing devices 120A-120N may comprise a group or collection of servers (e.g., computing devices) that are each accessible via a network such as the Internet (e.g., in a “cloud-based” embodiment) to store, manage, and process data. Each of computing devices 120A-120N may comprise any number of computing devices, and may include any type and number of other resources, including resources that facilitate communications with and between the servers, storage by the servers, etc. (e.g., network switches, storage devices, networks, etc.). Computing devices 120A-120N may be organized in any manner, including being grouped in server racks (e.g., 8-40 servers per rack, referred to as nodes or “blade servers”), server clusters (e.g., 2-64 servers, 4-8 racks, etc.), or datacenters (e.g., thousands of servers, hundreds of racks, dozens of clusters, etc.). In an embodiment, computing devices 120A-120N may be co-located (e.g., housed in one or more nearby buildings with associated components such as backup power supplies, redundant data communications, environmental controls, etc.) to form a datacenter, or may be arranged in other manners. Accordingly, in an embodiment, computing devices 120A-120N may each be a datacenter in a distributed collection of datacenters. In an embodiment, computing devices 120A-120N may comprise customer impacting computing equipment, such as computing equipment at a customer's physical location, computing equipment virtually accessible by a customer, or computing equipment otherwise relied upon or used by a customer.

Each of computing devices 120A-120N may be configured to execute one or more services (including microservices), applications, and/or supporting services. A “supporting service” is a cloud computing service/application configured to manage a set of servers (e.g., a cluster of servers in servers) to operate as network-accessible (e.g., cloud-based) computing resources for users. Examples of supporting services include Microsoft® Azure®, Amazon Web Services™, Google Cloud Platform™, IBM® Smart Cloud, etc. A supporting service may be configured to build, deploy, and manage applications and services on the corresponding set of servers. Each instance of the supporting service may implement and/or manage a set of focused and distinct features or functions on the corresponding server set, including virtual machines, operating systems, application services, storage services, database services, messaging services, etc. Supporting services may be written in any programming language. Each of computing devices 120A-120N may be configured to execute any number of supporting service, including multiple instances of the same supporting service.

In another embodiment, computing devices 120A-120N may include the computing devices of users (e.g., individual users, family users, enterprise users, governmental users, etc.) that are managed by an administrator. Computing devices 120A-120N may include any number of computing devices, including tens, hundreds, thousands, millions, or even greater numbers of computing devices. Each computing device of computing devices 120A-120N may be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server.

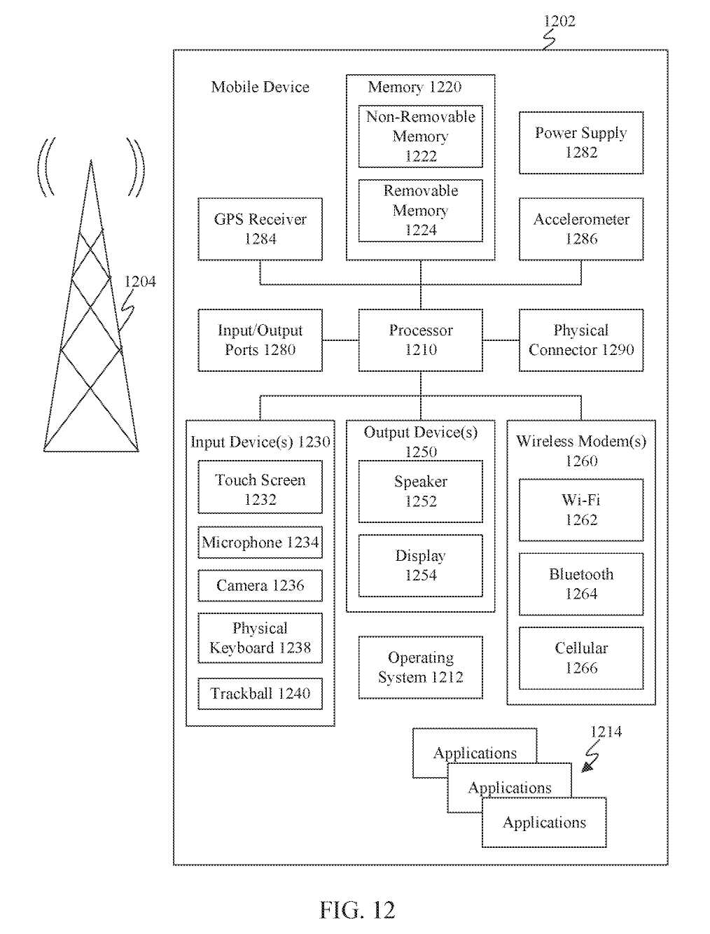

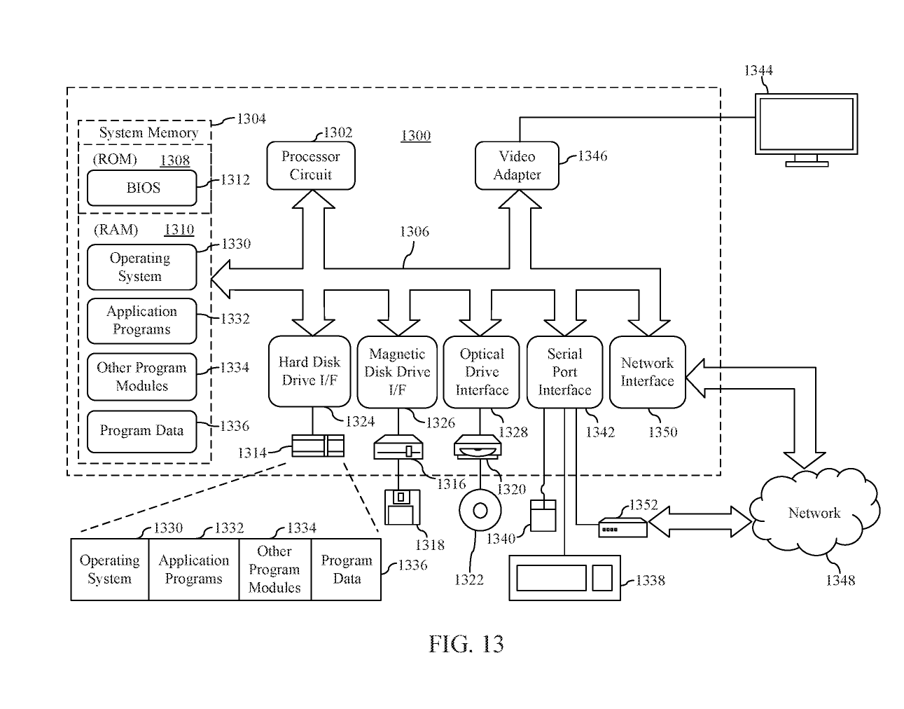

As shown in FIG. 1, computing device(s) 130 include an automated incident handler 132 for managing incidents generated or received by computing device(s) 130, according to an example embodiment. Computing device(s) 130 may represent a processor-based electronic device capable of executing computer programs installed thereon, and automated incident handler 132 may comprise such a computer program that is executed by computing device(s) 130. In one embodiment, computing device(s) 130 comprises a mobile device, such as a mobile phone (e.g., a smart phone), a laptop computer, a tablet computer, a netbook, a wearable computer, or any other mobile device capable of executing computing programs. One example of a mobile device that may incorporate the functionality of computing device(s) 130 will be discussed below in reference to FIG. 12. In another embodiment, computing device(s) 130 comprises a desktop computer, server, or other non-mobile computing platform that is capable of executing computing programs. An example desktop computer that may incorporate the functionality of computing device(s) 130 will be discussed below in reference to FIG. 13.

Although computing device(s) 130 is shown as a standalone computing device, in an embodiment, computing device(s) 130 may be included as a node(s) in one or more other computing devices (not shown), or as a virtual machine.

Automated incident handler 132 may, for example, comprise an incident management system configured to manage the generation of incidents on network(s) 110 or any of computing devices 120A-120N. Incidents, for instance, may be any type of incident, including but not limited to, incidents generated automatically by computing device(s) 130, network(s) 110, or any of computing devices 120A-120N. In an embodiment, incidents may also be generated manually by a user of computing device(s) 130 or any of computing devices 120A-120N. Incidents may comprise reports relating to any of computing device(s) 130, network(s) 110, or any of computing devices 120A-120N. For instance, an information technology incident may include any incident generated by monitoring activity on computing device(s) 130, network(s) 110, and/or any of computing devices 120A-120N. As an illustrative example, an information technology incident may include a report that any of computing devices 120A-120N are exceeding a threshold processor usage or a threshold temperature. In an embodiment, an information technology incident may include a report regarding a temperature of a physical location of computing devices 220A-220N, such as a server room. As another illustrative example, an information technology incident may include a report that a network ping exceeded a predetermined threshold. An information technology incident may also include any type of report relating to a customer-impacting issue, where a customer relies on, operates, or otherwise utilizes any of computing devices 120A-120N. However, these are examples only and are not intended to be limiting, and persons skilled in the relevant art(s) will appreciate that an information technology incident may comprise any event occurring on or in relation to a computing device, system or network.

In an embodiment, automated incident handler 132 provides an interface for a user to view, manage, and/or respond to incidents. Automated incident handler 132 may be configured to log actions of one or more users performed in respond to previously generated incidents. Using one or more user learned behaviors, automated incident handler 132 may be configured to recommend one or more actions to respond to new incidents. In this manner, automated incident handler 132 can utilize a machine-learning-based model to suggest an appropriate set of actions to automatically execute, thereby increasing a user's productivity in managing incidents. In an embodiment, a user interface presented by automated incident handler 132 provides a user with the ability to select any of the suggested actions, including a subset thereof, to execute on computing device(s) 130 to respond to an incident. In another embodiment, a user may reject the suggested actions and respond to the incident by manually performing one or more actions.

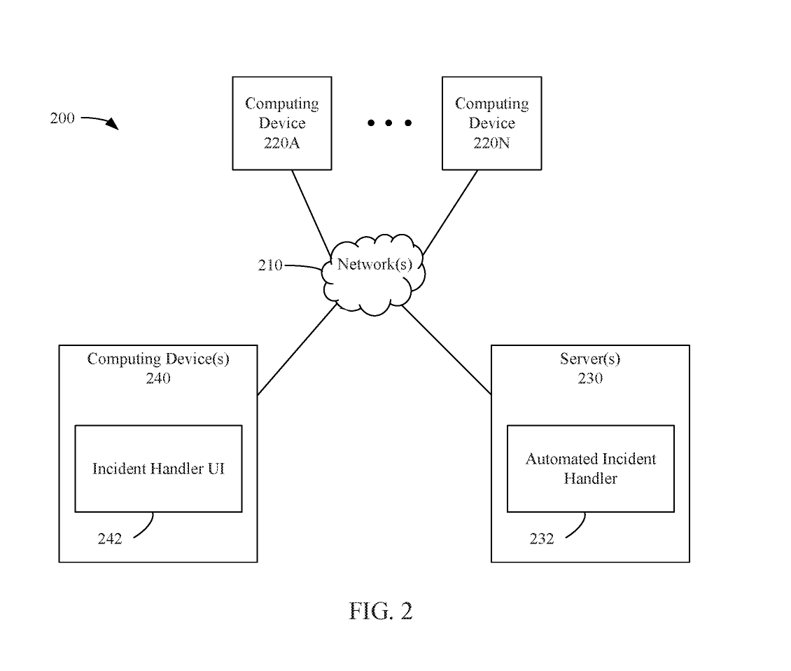

Turning now to FIG. 2, another example embodiment is described directed to a technique for enabling an automated handling of incidents in a computing environment. In particular, FIG. 2 shows a block diagram of an example system 200 comprising one or more server(s) 230 configured to enable the automated handling of incidents, according to an example embodiment.

Computing devices 220A-220N and network(s) 210 of FIG. 2 may be substantially similar to computing devices 120A-120N and network(s) 110, respectively, as described above with reference to FIG. 1. Computing devices 220A-220N and server(s) 230 are communicatively coupled via network(s) 210. In an embodiment, server(s) 230 manage incidents generated with respect to network(s) 210 or any of computing devices 220A-220N. In system 200, server(s) 230 execute an automated incident handler 232 for managing incidents generated or received by server(s) 230, according to an example embodiment. Server(s) 230 may represent a processor-based electronic device capable of executing computer programs installed thereon, and automated incident handler 232 may comprise such a computer program that is executed by server(s) 230. In an embodiment, server(s) 230 comprises a desktop computer, server, or other non-mobile computing platform that is capable of executing computing programs. An example desktop computer that may incorporate the functionality of server(s) 230 will be discussed below in reference to FIG. 13.

Although server(s) 230 is shown as a standalone computing device, in an embodiment, server(s) 230 may be included as a node(s) in one or more other computing devices (not shown), or as a virtual machine.

Automated incident handler 232 may, for example, comprise an incident management system configured to manage the generation of incidents on network(s) 210 or any of computing devices 220A-220N, in a manner similar to that described above with reference to automated incident handler 132 of FIG. 1. With reference to FIG. 2, automated incident handler 232 manages generated incidents, suggests one or more actions to execute to respond to generated incidents, and executes the one or more actions. Automated incident handler 232 may also be configured to log actions of one or more users operating computing device(s) 240 performed in response to previously generated incidents. As described above with reference to FIG. 1, automated incident handler 232 may be configured to recommend one or more suggested actions to a user based on one or more user learned behaviors.

Computing device(s) 240 may represent a processor-based electronic device capable of executing computer programs installed thereon. In one embodiment, computing device(s) 240 comprises a mobile device, such as a mobile phone (e.g., a smart phone), a laptop computer, a tablet computer, a netbook, a wearable computer, or any other mobile device capable of executing computing programs. One example of a mobile device that may incorporate the functionality of computing device(s) 240 will be discussed below in reference to FIG. 12.

In an embodiment, an incident handler user interface (UI) 242 may be provided on computing device(s) 240 that provides a user with the ability to select any of the one or more suggested actions received from automated incident handler 232 of server(s) 230, including a subset thereof, to execute on server(s) 230 to respond to an incident. In another embodiment, a user of computing device(s) 240 may reject the suggested actions through incident handler UI 242 and respond to a generated incident report by manually performing one or more actions on computing device(s) 240. In response to the user's selection through incident handler UI 242, automated incident handler 232 may execute one or more selected actions to respond to the generated incident. In this manner, although computing device(s) 240 may be separate from server(s) 230, server(s) 230 may nevertheless orchestrate a set of suggested actions for a user to select or reject in responding to an incident through a machine-learning-based model, thereby increasing a user's productivity in managing incidents.

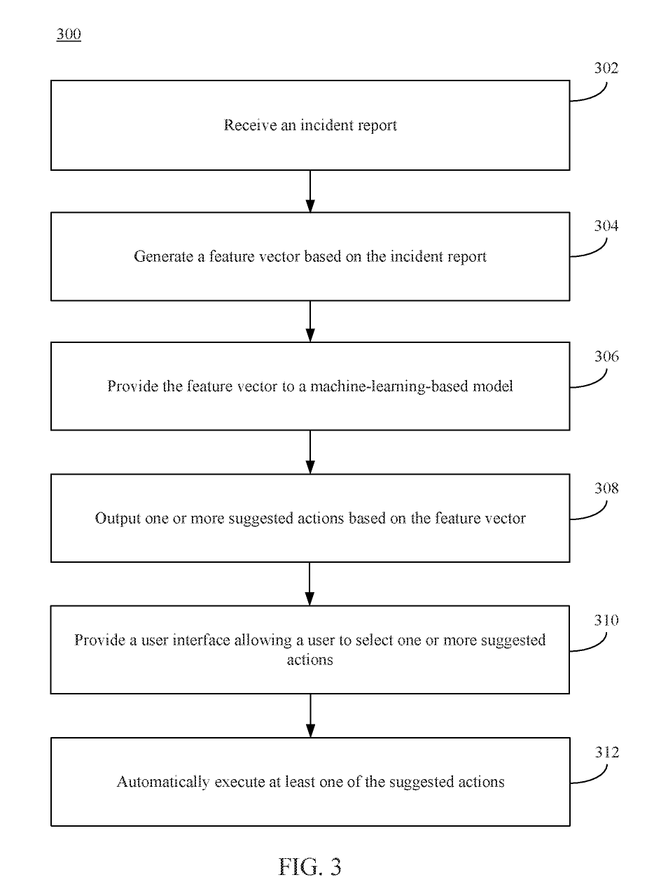

Accordingly, in embodiments, automated incident handling may be enabled on computing device(s) 130 or server(s) 230. Automated incident handler 132 and automated incident handler 232 may orchestrate the handling of incidents in various ways. For instance, FIG. 3 shows a flowchart 300 of a method for enabling an automated handling of incidents, according to an example embodiment. In an embodiment, the steps of flowchart 300 may be implemented by automated incident handler 132, automated incident handler 232, and/or incident handler UI 242. FIG. 3 is described with continued reference to FIGS. 1 and 2. Other structural and operational embodiments will be apparent to persons skilled in the relevant art(s) based on the following discussion regarding flowchart 300, system 100 of FIG. 1, and system 200 of FIG. 2.

Flowchart 300 begins with step 302. In step 302, an incident report is received. For example, automated incident handler 132 described with reference to FIG. 1 or automated incident handler 232 described with reference to FIG. 2 receives an incident report. Incident reports may be generated automatically by network(s) 110, any one of computing devices 120A-120N, computing device(s) 130, network(s) 210, any one of computing devices 220A-220N, or server(s) 230. Incident reports may also be generated manually by a user of any device connected to network(s) 110 or network(s) 210, including through incident handler UI 242. In an embodiment, the incident report may be any type of report regarding network(s) 110 or computing devices 120-120N of FIG. 1, or network(s) 210 or computing devices 220A-220N of FIG. 2. For instance, the incident report may relate to an information technology incident. As an illustrative example, an information technology incident may include a report that one or more computing devices are exceeding a threshold processor usage or a threshold temperature. In an embodiment, an information technology incident may include a report regarding a temperature of a physical location of any of computing devices 120A-120N or computing devices 220A-220N, such as a server room. An information technology incident may also include any type of report relating to a customer-impacting issue, where a customer relies on, operates, or otherwise utilizes any of computing devices 120A-120N or computing devices 220A-220N. However, these examples are not intended to be limiting, and persons skilled in the relevant art(s) will appreciate that an incident report may relate to still other types of information technology incidents.

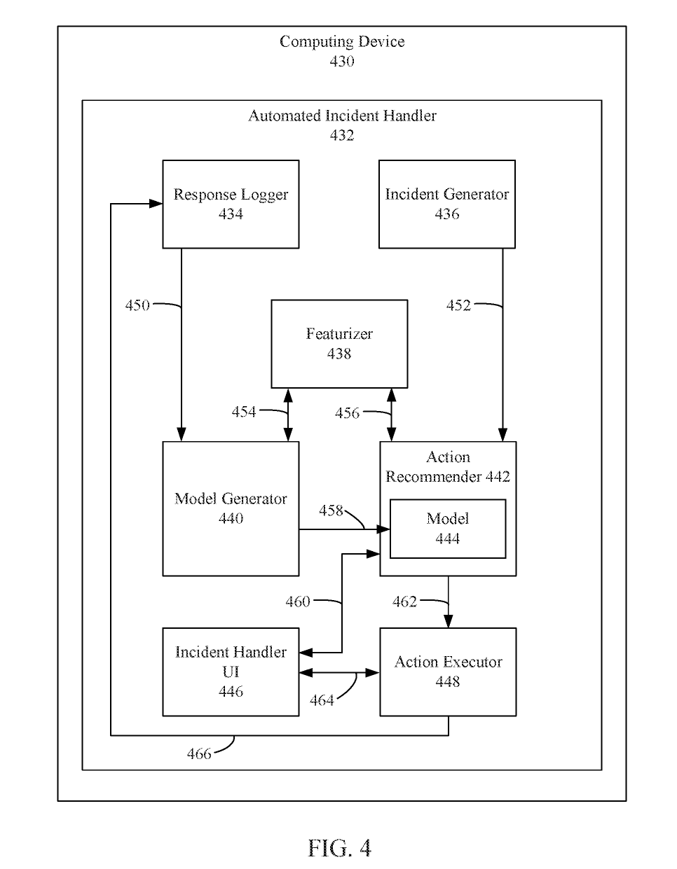

Step 302 may also be performed in accordance with various other embodiments. For instance, FIG. 4 shows a block diagram of a computing device 430, according to an example embodiment. Computing device 430 may be an example of one of computing device(s) 130 of FIG. 1 or server(s) 230 of FIG. 2. As shown in FIG. 4, computing device 430 includes an automated incident handler 432. Automated incident handler 432 of FIG. 4 may be substantially similar to automated incident handler 132 described above with reference to FIG. 1 or automated incident handler 232 described above with reference to FIG. 2. As shown in FIG. 4, automated incident handler 432 comprises a response logger 434, an incident generator 436, a featurizer 438, a model generator 440, an action recommender 442 comprising a model 444, an incident handler user interface (UI) 446, and an action executor 448.

In accordance with step 302, incident generator 436 of FIG. 4 may be configured to generate an incident report in substantially similar manner as described above with reference to FIGS. 1 and 2. In an embodiment, generation of an incident report may include receiving an incident report from computing device 430, or from any of network(s) 110, network(s) 210, computing devices 120A-120N, and/or computing devices 220A-220N.

In step 304, a feature vector is generated based on the incident report. For instance, with reference to FIG. 4, incident generator 436 may provide 452 the incident report to action recommender 442. Once the incident report is received, action recommender 442 may provide 456 the incident report to featurizer 438 to generate a feature vector based on the incident report as input to model 444 in determining one or more suggested actions to execute in response to the incident report. Featurizer 438 may extract information from the incident report to generate a feature vector for the incident report. For example, featurizer 438 may be configured to extract features, or other distinguishable characteristics, of an incident report to generate a representation that incident report. The feature vector generated in featurizer 438 may take any form, such as a numerical and/or textual representation, or may comprise any other form suitable for representing an incident report. In an embodiment, a feature vector may include features such as keywords, a total number of words, and/or any other distinguishing aspects relating to an incident report that may be extracted therefrom.

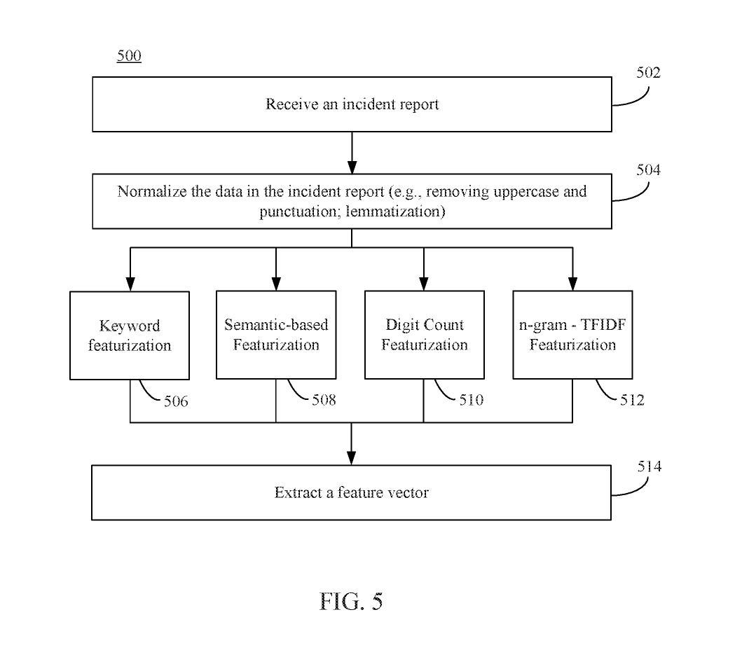

Featurizer 438 may operate in a number of ways to featurize, or generate a feature vector for, an incident report. For example and without limitation, featurizer 438 may featurize an incident report through keyword featurization, semantic-based featurization, digit count featurization, and/or n-gram-TFIDF featurization. Each of these manners of featurization will be discussed in more detail with respect to FIG. 5, below.

In step 306, the feature vector is provided to a machine-learning-based model. For instance, with respect to FIG. 4, the feature vector obtained from featurizer 438 may be provided 456 as an input to a model (or algorithm) 444 used by action recommender 442. Action recommender 442 uses a machine-learning-based model 444 to recommend a set of actions for a given incident report, wherein the model is generated by model generator 440 and is trained 458 on the behaviors of one or more users in responding to incident reports as logged by response logger 434. For example, response logger 434 may be configured to log each action a user, such as an administrator responsible for responding for handling incident reports, performs to in response to a given incident report. In an embodiment, response logger 434 may log an entire sequence of actions a user performs in response to a given incident report. In an embodiment, model generator 440 is configured receive 450 an incident report logged by response logger 434. Model generator 440 may provide 454 the incident report logged by response logger 434 to featurizer 438 to generate 454 a feature vector for the incident report. Using the generated feature vector from featurizer 438 and the actions logged by response logger 434 taken in response to the incident report corresponding to the generated feature vector, model generator 440 trains model 444. In this manner, model 444 may be trained based on the actions a user has taken in response to a feature vector corresponding to a previous incident report. In embodiments, model generator 440 continuously trains model 444 based on actions taken by a user or users in response to incident reports, thereby continuously increasing the breadth of model 444.

In an embodiment, a response logger 434 may log only a subset of the actions performed in response to an incident. In another embodiment, response logger 434 may log not only actions performed within the incident management system, but may also log one or more actions performed on one or more computing devices external to the incident management system. For instance, in responding to an incident report, a user may access an application or service external to the incident management system to report a bug for use in a future testing scenario. In this illustrative example, response logger 434 may be configured to log the user's actions performed external to the incident management system. In this example, model generator 440 may obtain a feature vector using featurizer 438 in the same manner as discussed above, and train model 444 using at least the actions performed external to the incident management system corresponding to the extracted feature vector corresponding to the incident report. In this manner, action recommender 442 may output a set of suggested actions to execute external to the incident management system based on a feature vector corresponding to an incident report generated by incident generator 436. Automated incident handler 432 thereby may allow for extensibility by unifying a workflow across the various services and systems.

Response logger 434 may also log any other type of action performed by a user in association with a given incident report, such as mitigating an incident for not having any customer impact. As another illustrative example, for a different incident report, response logger 434 may be configured to store a different sequence of events, such as owning the incident, adding a current date and time, and modifying a severity rating associated with the incident. In another embodiment, response logger 434 may additionally log a user input, such as text inserted by a user in a text field, in responding to an incident report.

In yet another embodiment, response logger 434 may also log the actions of a plurality of users, for instance, where an incident response team includes more than one user responsible for responding to incidents. For instance, response logger 434 may log the actions of an entire organization's information technology staff responsible for responding to incident reports. In this manner, model generator 440 may utilize response logger 434 to train model 444 on a per-user basis, or may train model 444 across a plurality of users or groups within an organization responsible for handling incident reports.

In the above manner, model 444 used by action recommender 442 to recommend actions may be trained based on previous actions executed in relation to previous incident reports. For instance, model 444 used by action recommender 442 may be trained based on the behavior of one or more user's actions performed for a given incident report through response logger 434. In an embodiment, model 444 used by action recommender 442 is continuously trained based on users' behaviors without any significant user action. For instance, response logger 434 may run in the background of computing device 430 and continuously and automatically log 466 each action performed by a user or executed by action executor 448 for a given incident report. In another embodiment, a response logger similar to response logger 434 may run in the background of any of computing device(s) 130, computing device(s) 240, and/or server(s) 230 to log actions performed for incident reports in a similar manner. As the number of logged incident reports, and logged actions taken in response to the logged incident reports continues to increase in response logger 434, model 444 generated by model generator 440 and used by action recommender 442 may become increasingly accurate.

As an illustrative example, an incident report may comprise a report that one or more of computing devices 120A-120N or computing devices 220A-220N are utilizing more than a threshold percentage of the computing device's processing capability. In this illustrative example, because the computing device's processor usage will eventually drop below the threshold, the incident report may be regarded as noise. In such a scenario, a user or administrator may determine that the incident is merely a transient issue. In this illustrative example, upon receipt of such an incident report, a user may manually perform a set of actions in a particular sequence including owning the incident, adding a current date and time, mitigating the status of the incident as noise, and resolving the incident, thereby closing it without any further action. In this example, response logger 434 is configured to log each action for the incident report, including owning the incident, adding a current date and time, mitigating the status of the incident as noise, and resolving the incident. Model generator 440 may the incident report from response logger 434 and provides the incident report to featurizer 438 to generate a feature vector corresponding to the incident report. The feature vector for the incident report and the sequence of actions can then be used as training data by model generator 440 to train model 444 to be used by action recommender 442.

In step 308, one or more suggested actions is output based on the feature vector. With reference to FIG. 4, action recommender 442 receives an incident report generated by incident generator 436 (as discussed above in reference to step 302). Action recommender 442 provides the incident report to featurizer 438 to extract a feature vector corresponding to the incident report (as discussed above in references to step 304). Action recommender 442 provides the feature vector extracted by featurizer 438 to model 444 generated by model generator 440 (as discussed above in reference to step 306) and receives as output therefrom one or more suggested actions for orchestrating a response to the incident report represented by the feature vector (step 308). Action recommender 442 may output a single suggested action, a set of suggested actions, or an entire orchestrated sequence of suggested actions to be performed in a particular order based on previously learned behaviors in model 444 generated by model generator 440.

In embodiments, action recommender 442 may take into account additional factors in determining the one or more suggested actions to output, and/or how the one or more suggested actions are prioritized or ranked. For instance, in one embodiment, action recommender 442 may take into account training data across a plurality of users, such as a plurality of users, groups, or teams within a larger organization. In other embodiments, action recommender 442 may consider one or more factors that are personalized to a user in outputting suggested actions. For instance, in an embodiment, action recommender 442 may output suggested actions by considering training data for a particular user, such as a user of computing device 430.

In accordance with embodiments, action recommender 442 may also consider various additional factors personalized to a user when outputting suggested actions. In one embodiment, action recommender 442 may take into account an efficiency of prior actions executed by the user in response to incident reports, such as whether certain actions resolved an incident report quicker than alternative actions that resulted in a delayed resolution. Action recommender 442 may also take into account an effectiveness of prior actions executed by the user, such as whether certain actions were more effective at resolving an incident report, compared to alternative actions that caused errors in an incident management system, or otherwise failed to complete. In yet another scenario, action recommender 442 may consider that certain actions resolved an incident report with relatively little to no customer impact compared to alternative actions that resulted in a greater customer impact during resolution.

In yet another embodiment, action recommender 442 may take into account a user's preferences or settings in outputting suggested actions. For example, incident handler UI 446 may provide an interface for a user to specify one or more preferences or settings that affect a type and/or ordering of suggested actions output by action recommender 442. In an embodiment, incident handler UI 446 may comprise an interface on an application residing on mobile device, an interface provided on a website or a web-based application, or any other suitable interface in which a user may configure which factors action recommender 442 may take into account.

Incident handler UI 446 may allow a user to configure action recommender 442 to consider any of the personalized factors described herein when outputting suggested actions. For instance, a user may specify a preference that the suggested actions be based on a popularity of the actions across a plurality of users in responding to incident reports. In another embodiment, incident handler UI 446 may allow a user to specify a preference to prioritize suggested actions based on the most recent manner of responding to an incident report. In yet another embodiment, a user may configure action recommender 442 to output suggested actions based on the type of actions preferred by a user. For example, where a user prefers only certain types of actions in responding to a given incident report, action recommender 442 may be configured, through incident handler UI 446, to output or prioritize the types of actions consistent with the user's preferences.

In yet another embodiment, action recommender 442 may consider the attributes of a user (e.g., a user of computing device 430). For example, computing device 430 may contain metadata regarding its user, such as the user's domain expertise, job type/description (e.g., a developer versus a service engineer), level (e.g., based on years of employment or managerial status), geographic location, responsibility/ownership of certain services, products, and/or components. Action recommender may take any of these attributes into account in tailoring which suggested actions to output, the prioritization of the actions, and/or ranking of the actions.

In yet another embodiment, action recommender 442 may consider other factors, such as the team, service, or group for which a user of an organization belongs. For example, by considering information regarding a user's role in an organization, action recommender 442 may automatically determine which features of a service, product, or component the user may be responsible. In another example, action recommender 442 may take into account the types of incident reports assigned to a particular team in the past, and/or the types of actions one or more members of the team recently executed. In another embodiment, action recommender 442 may consider a dependency graph of a particular team's services relative to one or more other teams' services. For instance, action recommender 442 may utilize information regarding which one of several teams may be primarily responsible for responding to an incident and/or whether a particular team's actions to respond to an incident may depend on the services offered by another team.

The techniques in which action recommender 442 may consider additional personalized factors in outputting one or more suggested actions are not, however, limited to the above examples. Action recommender 442 may consider any combination of the above factors, or any other facts as may be understood and appreciated by one skilled in the relevant art, in outputting, prioritizing, and/or ranking suggested actions.

As an illustrative example, if an incident report was generated for an incident indicating that a computing device was operating above a certain temperature, action recommender 442 may provide the incident report to featurizer 438 to extract a feature vector corresponding to the incident report that the computing device was operating above a certain temperature. Action recommender 442 may provide the feature vector to model 444 to determine that one or more users of computing device(s) 130 or computing device(s) 240 previously responded to the incident by owning the incident, adding a current date and time, mitigating the status of the incident as noise, and resolving the incident. In this illustrative example, action recommender 442, through model 444, may output an orchestrated sequence of suggested actions comprising owning the incident, adding a current date and time, mitigating the status of the incident as noise, and resolving the incident, based on previously learned behaviors.

In an embodiment, model 444 may output a plurality of sets of suggested actions based on trained data from model generator 440. For instance, in an embodiment, a user may respond to the same incident report in differing manners. In another embodiment, a plurality of users may respond to the same incident report in different manners. In these examples, model generator 440 may be configured to train model 444 with differing orchestrated sequences of actions taken in response to the same feature vector corresponding to an incident report. In the event action recommender 442 provides model 444 with a feature vector corresponding to the same incident report, model 444 may output one or more of sets of suggested actions based on learned behaviors. In another embodiment, model 444 may output a single set of suggested actions corresponding to the most common manner of responding to the incident report corresponding to the feature vector. For example, model 444 may make a priority determination, determine a confidence value, or determine a ranking regarding the suggested actions based on the prior actions executed in response to the same feature vector corresponding to the incident report. In this embodiment, model 444 may output one or more suggested actions based on the highest priority determination, confidence value or ranking indicative of how a user is likely to respond to the incident report. In another embodiment, model 444 may output a plurality of sets of suggested actions corresponding to more than one priority determination, confidence value, or ranking. For instance, as an illustrative example, model 444 may output three separate sets of suggested actions based on the three highest confidence values or rankings. In another embodiment, model 444 may be configured to output one or more suggested actions only model 444 has been trained by model generator 440 with a predetermined threshold of learned behaviors for the incident report corresponding to the feature vector. In this manner, action recommender, through model 444, can determine, with a greater level of confidence, a set of suggested actions to perform in response to an incident report.

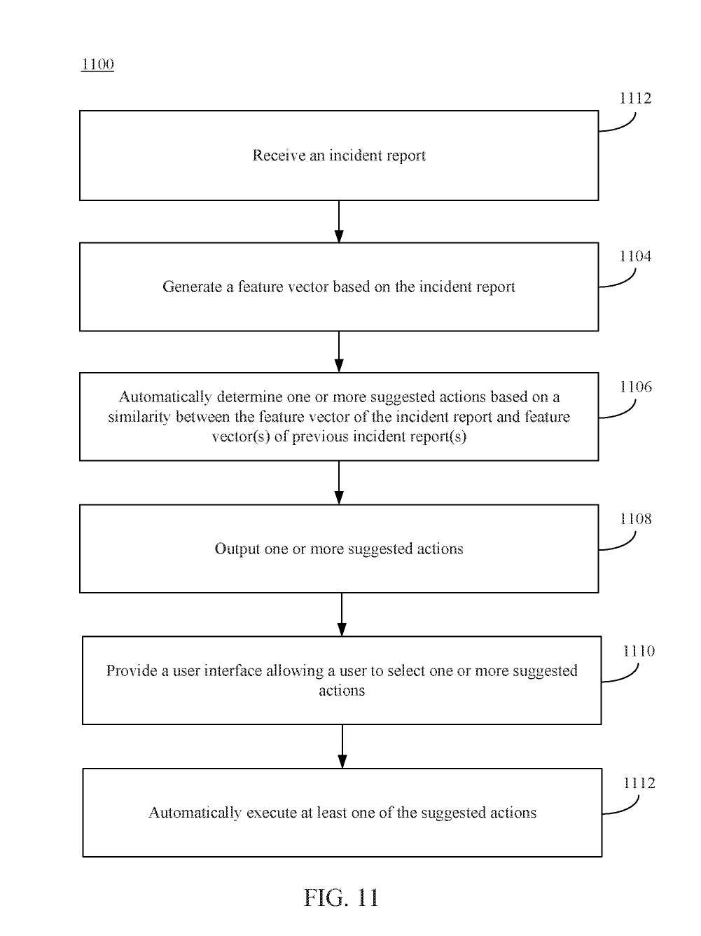

In yet another embodiment, model generator 440 may not have trained model 444 with training data for a feature vector representing an incident report. In this example, model 444 may be output a message indicating that suggested actions are not available for the incident report corresponding to the feature vector provided to model 444. In another embodiment, which will be discussed in greater detail below with reference to FIG. 11, action recommender 442 may output one or more suggested actions based one or more feature vectors that are determined to be similar to the input feature vector and that correspond to other incident reports.

In another example, action recommender 442 may be configured to automatically assign an incident report to a particular user or team. For instance, action recommender 442 may receive a feature vector from featurizer 438 corresponding to an incident report. Action recommender 442 may provide that feature vector to model 444, which automatically assigns the incident report to a certain user or team based on learned behaviors regarding prior ownership of a feature vector corresponding to the incident report. In another embodiment, the assignment of incident reports to a user or team may be based on any other prediction service employed in an incident management system known in the art.

In step 310, a user interface is provided that allows a user to select one or more suggested actions outputted by a machine-learning-based model. For instance, with continued reference to FIG. 4, incident handler UI 446 provides an interface for a user to select one or more suggested actions output 460 by action recommender 442 through model 444. In an embodiment, incident handler UI 446 may be part of computing device 430, as shown in FIG. 4. In another embodiment, a user may be remotely located with respect to a server in which action recommender 442 may be implemented. For example, with reference to FIG. 2, the user interface may be provided on a separate computing device(s) 240 through incident handler UI 242. In this embodiment, a user may remotely select one or more suggested actions output by server(s) 230 through interaction with incident handler UI 242.

Incident handler UI 242 and incident handler UI 446 may comprise any suitable interface by which a user may view, manage, select, or otherwise interact 460 with the one or more suggested actions outputted by action recommender 442. For instance, incident handler UI 242 and incident handler UI 446 may be any one of a graphical user interface, touch screen interface, audio (e.g., voice) interface, or any other interface. In an embodiment, one or more of computing device(s) 240 may be a remote terminal. In such an embodiment, incident handler UI 242 may be provided through an application stored and/or executed on the remote terminal, or alternatively may be provided as a website or web-based application that a user can access to view, manage, and/or select one or more suggested actions outputted by action recommender 442.

In an embodiment, a user may select any number of suggested actions outputted by action recommender 442. For instance, where action recommender 442 outputs more than one suggested actions, a user may select a single suggested action from the more than one suggested actions, or may select all of the suggested actions. In an embodiment, a user may select a subset of suggested actions from the more than one suggested actions. Incident handler UI 242 and incident handler UI 446 may display suggested actions to perform in the form of text, graphical images, icons, or any other suitable manner. For instance, in an embodiment, incident handler UI 242 and incident handler UI 446 may display suggested actions to a user in the form of a decision tree through which a user may select one or more actions to automatically execute. In an embodiment, incident handler UI 242 and incident handler UI 446 allow a user to select one or more suggested actions to automatically execute through minimal user involvement. For instance, selecting one or more suggested actions may be accomplished by a single click of a mouse or touchpad, or by a single depression of a keyboard key, although these examples are not intended to be limiting.

Incident handler UI 242 and incident handler UI 446 may also provide the ability for a user to change an ordering of the suggested actions outputted by action recommender 442. For instance, if action recommender 442 outputs a particular orchestrated sequence of suggested actions, a user may optionally change the ordering of the orchestrated sequence of actions. In another embodiment, a user may add other actions not output by action recommender 442. Incident handler UI 242 and incident handler UI 446 may further provide an ability for a user to select one or more actions to be performed, followed by an instruction to pause the execution of the suggested actions. For instance, a user may desire to perform only a subset of actions, after which a user may wish to manually intervene in the process of responding to the incident.

In an embodiment, incident handler UI 242 and incident handler UI 446 may also permit a user to reject and/or modify one or more of the suggested actions and/or manually substitute a different set of actions to perform in responding to an incident. Incident handler UI 242 and incident handler UI 446 may also be configured to permit a user to add, modify, or remove a text-based input in addition to selecting one or more suggested actions.

In an embodiment, incident handler UI 242 and incident handler UI 446 may be configured to display a priority determination, confidence value, or a ranking regarding the suggested actions based on the prior actions executed in response to the same feature vector corresponding to the incident report. In another embodiment, more than one priority determination, confidence value, or ranking may be displayed to a user, for example, when model 444 outputs a plurality of sets of suggested actions. In this manner, a user may utilize the displayed priority determination, confidence value or ranking in determining whether to select one or more of the suggested actions provided by model 444.

In another example, a user of the incident management system may choose to manually create a set of suggested actions to respond to an incident. For instance, incident handler UI 242 and incident handler UI 446 may provide an interface by which a user may create one or more macros containing a set of actions to execute for an incident. Incident handler UI 242 and incident handler UI 446 may be further configured to provide an interface in which a user may display the macros. In this instance, incident handler UI 242 and incident handler UI 446 may permit a user to optionally select one or more macros to respond to an incident report. Upon selection of the one or more macros, the macros may be automatically executed.

In step 312, at least one of the suggested actions are automatically executed. With reference to FIG. 4, upon receiving a user's selection of one or more of the suggested actions through a user interface, action executor 448 automatically executes the one or more suggested actions selected by the user. In an embodiment, incident handler UI 446 may output 464 the one or more suggested actions selected by the user to action executor 448. In another embodiment, action recommender 442, in response to a user input, may output 462 the one or more suggested actions selected by the user to action executor 448.

In an illustrative example, incident handler UI 242 or incident handler UI 446 may display an orchestrated set of suggested actions comprising owning the incident, adding a current date and time, mitigating the status of the incident as noise, and resolving the incident. In this example, if a user selects the entire orchestrated sequence of suggested actions, action executor 448 automatically performs the selected actions on computing device 430 to respond to the incident. Action executor 448 may also be configured to automatically update a status of the incident report. For instance, action executor 448 may automatically mark the incident report as noise or mitigated, and/or may update the incident report with a status or history of the actions automatically performed in responding to the incident report.

In an embodiment, incident handler UI 242 or incident handler UI 446 may permit a user to interact 464 with the automatic execution of the selected actions by action executor 448. display an execution progress of the suggested actions a user has selected to perform. In another embodiment, a user may pause the automatic execution of the selected actions through incident handler UI 242 or incident handler UI 446 and optionally resume the automatic execution or manually complete a process of responding to the incident. In another embodiment, incident handler UI 242 and incident handler UI 446 may permit a user to add, modify, or remove a text-based input during the automatic execution of the one or more suggested actions. For instance, action executor may pause the automatic execution in the event one or more of the suggested actions comprises a text-based field in suggested text may be displayed to a user as a draft. In this example, a user may add, modify, or delete text, after which the automatic execution may be resumed. In yet another embodiment, a user may optionally undo one or more actions automatically executed by action executor 448.

In the above manner, automated incident handler 132, automated incident handler 232, and automated incident handler 432 provide the ability to automatically orchestrate a set of actions likely to be selected by a user to respond to an incident report, thereby increasing a user's productivity. Moreover, as users continue to respond to incident reports, the learned behavior of automated incident handler 132, automated incident handler 232, and automated incident handler 432 increases, thereby increasing the accuracy of the machine-learning-based model.

As described above, in an embodiment, automated incident handler 132, automated incident handler 232, and automated incident handler 432 may generate a feature vector corresponding to a generated incident report. For instance, FIG. 5 shows a flowchart 500 for extracting a feature vector based on an incident report according to an example embodiment. In an embodiment, flowchart 500 may be implemented by any of automated incident handler 132, automated incident handler 232, and automated incident handler 432, as shown in FIGS. 1, 2, and 4. The method of flowchart 500 may be used, for example, to implement step 304 of flowchart 300. Other structural and operational embodiments will be apparent to persons skilled in the relevant art(s) based on the following discussion regarding flowchart 500.

Flowchart 500 begins with step 502. In step 502, an incident report is received. In an embodiment, step 502 of FIG. 5 may be performed in a substantially similar manner as described above with reference to step 302 of FIG. 3.

In step 504, data in the incident report is normalized. For instance, an incident report generated by incident generator 436 may be provided to action recommender 442. Upon receiving the incident report, action recommender 442 may be configured to automatically provide the incident report to featurizer 438 which normalizes the data contained within the incident report. In an embodiment, normalizing the data in an incident report may include removing all uppercase characters and/or removing all punctuation. Normalizing data in an incident report may also include lemmatization. Lemmatization, for example, may include analyzing words contained within the incident report and removing inflectional word endings. In this manner, the base or dictionary form of a word may be obtained.

Once data in the incident report is normalized, the normalized incident report is featurized, for example, in step 506, step 508, step 510, and/or step 512, as shown in FIG. 5. For instance, with reference to FIG. 4, featurizer 438 may featurize an incident report in accordance with any of step 506, step 508, step 510, and/or step 512 to generate a feature vector.

In step 506, the normalized incident report may undergo a keyword featurization. For instance, keywords in an incident report may be analyzed during a featurization process in which a feature vector is extracted based on the keywords. For example, any number of keywords may be used by featurizer 438 in determining a keyword portion of the feature vector (e.g., any number of Boolean entries for pre-determined keywords either being present or not present in the incident report).

In step 508, the neutralized incident report may undergo a semantic-based featurization. During a semantic-based featurization, for example, unstructured data in an incident report may be analyzed, after which features are extracted. Unstructured data, for instance, may include incident report text that is not in a standard format (e.g., freeform text fields) such as comments input by a user or customer. In an embodiment, the semantic-based featurization may analyze such unstructured data to extract features corresponding to the incident report.

In step 510, the normalized incident report may undergo a digit count featurization. Digit count featurization may comprise a statistical analysis of the occurrences of number, letter, and special characters in an incident report. Based on the statistical analysis, features corresponding to the incident report may be extracted.

In step 512, the neutralized incident report may undergo an n-gram-TFIDF featurization. N-grams may include, for instance, contiguous sequence of n items, where n is a positive integer. TFIDF includes both term frequency (TF) and inverse document frequency (IDF). During Ngram-TFIDF featurization, strings of characters or words, for instance, may be analyzed after which features corresponding to the incident report are extracted. N-gram and char-gram featurizations may also be implemented to determine numbers of word and/or character groups present in the information.

It is noted that the above described featurization techniques are illustrative examples only. Featurizer 438 may featurize an incident report in any other suitable manner, including but not limited to a K-means clustering featurization, a context-based featurization, and/or a feature selection featurization. Feature vectors generated may comprise any number of feature values (i.e., dimensions) from tens, hundreds, thousands, etc., of feature values in the feature vector. Context- and semantic-based featurization may also be performed by featurizer 210 to provide structure to unstructured information that is received. For example, semantic-based feature sets may be extracted by featurizer 438 for technical phrases from the incident report. Sematic-based features sets may comprise, without limitation, domain-specific information and terms such as global unique identifiers (GUIDs), universal resource locators (URLs), emails, error codes, customer/user identities, geography, times/timestamps, and/or the like. Count- and/or correlation-based feature selection as featurization may also be performed by featurizer 438 on text associated with the normalized incident report to determine if system/service features are present and designate such system/service features in the feature vector. In an embodiment, a normalized incident report may undergo any one of the above-described featurization techniques, or a combination thereof.

In step 514, a feature vector is extracted. For instance, by combining one or more features generated by one or more of keyword featurization 506, semantic-based featurization 508, digit count featurization 510 and n-gram—TFIDF featurization 512, a feature vector for the incident report received during step 502 may be extracted.

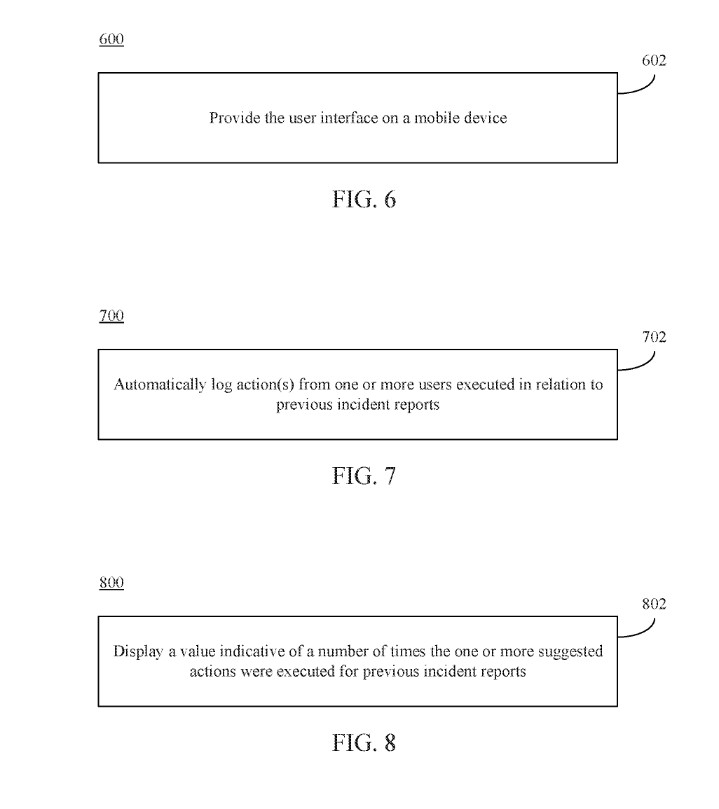

As described above, in an embodiment, incident handler UI 242 may be accessible via a remote device, such as a mobile device. For instance, FIG. 6 shows a flowchart 600 for providing the user interface for an automated incident handler on a mobile device, according to an example embodiment. In an embodiment, flowchart 600 may be implemented by one or more of computing device(s) 240 and incident handler UI 242 of FIG. 2. Other structural and operational embodiments will be apparent to persons skilled in the relevant art(s) based on the following discussion regarding flowchart 700.

Flowchart 600 begins with step 602. In step 602, the user interface of an automated incident handler is provided on a mobile device. For example, with reference to FIG. 2, incident handler UI 242, which permits a user to view, manage and/or select one or more suggested actions to execute, may be provided on computing device(s) 240. Computing device(s) 240 may comprise one or more mobile devices, such as a mobile phone (e.g., a smart phone), a laptop computer, a tablet computer, a netbook, a wearable computer, or any other mobile device capable of executing computing programs. An example of a mobile device that may incorporate the functionality of computing device(s) 240 will be discussed below in reference to FIG. 12. Incident handler UI 242 may be provided through an application stored and/or executed on the mobile device, or alternatively may be provided as a website or web-based application or through which a user can access to view, manage, and/or select one or more suggested actions output by the action recommender.

As described above, in an embodiment, response logger 434 of computing device 430 may automatically log the actions performed by one or more users corresponding to an incident report. For instance, FIG. 7 shows a flowchart 700 for automatically logging actions, according to an example embodiment. In an embodiment, flowchart 700 may be implemented by response logger 434 of computing device 430, as shown in FIG. 4. Other structural and operational embodiments will be apparent to persons skilled in the relevant art(s) based on the following discussion regarding flowchart 700.

Flowchart 700 begins with step 702. In step 702, actions executed by one or more users in relation to previous incident reports are automatically logged for a given incident report. For instance, with reference to FIG. 4, response logger 434 may run in the background of computing device 430 and continuously and automatically log each action performed by a user for an incident report. In another embodiment, a response logger similar to response logger 434 may run in the background of any of computing device(s) 130, computing device(s) 240, and/or server(s) 230 to continuously and automatically log each user's actions performed in response to incident reports. In this manner, model 444 is continuously and automatically trained based on one or more users' behaviors with minimal user involvement. As the number of logged incident reports and actions taken in response to logged incidents continues to increase in response logger 434, model generator 440 may continuously train model 444, thereby rendering model 444 increasingly accurate in suggesting one or more actions to execute in response to an input feature vector corresponding to an incident report generated by incident generator 436.

In an embodiment, incident handler UI 242 and incident handler UI 44 may be configured to display additional information corresponding to one or more suggested actions output by the action recommender. For instance, FIG. 8 shows a flowchart 800 for displaying additional information on a user interface, according to an example embodiment. In an embodiment, flowchart 800 may be implemented by incident handler UI 242 of computing device(s) 240, as shown in FIG. 2, and/or incident handler UI 446 of computing device 430, as shown in FIG. 4. Other structural and operational embodiments will be apparent to persons skilled in the relevant art(s) based on the following discussion regarding flowchart 800.

Flowchart 800 begins with step 802. In step 802, a value indicative of a number of times the one or more suggested actions were executed for previous incident reports may be displayed on a user interface. For example, with reference to FIG. 4, incident handler UI 446 may display a percentage or other quantity that is representative of how often a user, a plurality of different users, and/or a group of users performed the one or more suggested actions in response to previous incident reports. In yet another embodiment, action recommender 442 may output a plurality of suggested sequences of actions, and provide a user with an option of selecting one of the sequences to execute. In such an embodiment, incident handler UI 446 may display a percentage or quantity corresponding to each suggested sequence.

By displaying one or more percentages or quantities in the above manner, a user of computing device 430 may be provided with information that is helpful in determining whether to accept the one or more actions suggested by action recommender 442 in response to a generated incident report. For instance, if a user interface indicates that a user or users performed a suggested sequence of actions 98% of the time a same or similar incident report was generated in the past, the user may choose to accept one or more suggested actions, thereby permitting action executor 448 to perform the suggested actions.

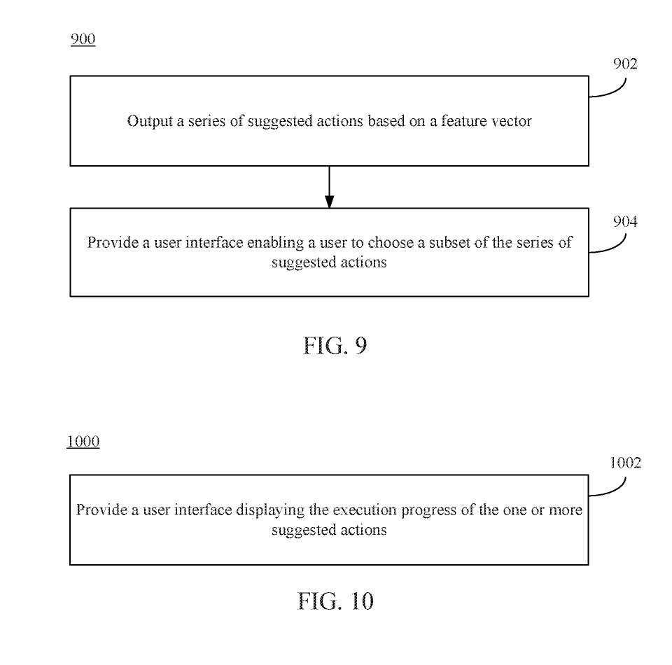

As described above, in an embodiment, action recommender 442 may be configured to output a series of suggested actions for closing an incident. For instance, FIG. 9 shows a flowchart 900 for permitting a user to select a subset of a series of suggested actions, according to an example embodiment. In an embodiment, flowchart 900 may be implemented by incident handler UI 242 of computing device(s) 240, as shown in FIG. 2, incident handler UI 446, as shown in FIG. 4, and/or action recommender 442, as shown in FIG. 4. Other structural and operational embodiments will be apparent to persons skilled in the relevant art(s) based on the following discussion regarding flowchart 900.

Flowchart 900 begins with step 902. In step 902, a series of actions is suggested based on a generated feature vector. Step 902 of FIG. 5 may be performed in a similar manner as described above with reference to step 308 of FIG. 3. For instance, with reference to FIG. 4, action recommender 442 may output a series of suggested actions, through model 444, such as a set of actions or an entire orchestrated sequence of actions to be performed in a specified order based on a feature vector extracted by featurizer 438 corresponding to an incident report generated by incident generator 436.

In step 904, a user interface is provided that enables a user to choose a subset of the series of actions. For instance, incident handler UI 242 or incident handler UI 446 may display the series of suggested actions on a user interface. A user may select, individually or as a group, a subset of actions from the series of suggested actions to execute through incident handler UI 242 or incident handler UI 446. For instance, a user may select only a portion of the suggested actions to be executed automatically and manually insert or perform different actions to respond to the incident report. As discussed above with reference to FIGS. 3 and 4, in response to a user's selection of actions via incident handler UI 242 or incident handler UI 446, one of server(s) 230 or computing device 430 may execute the subset of actions automatically to respond to the incident.

As described above, in an embodiment, incident handler UI 242 or incident handler UI 446 may display an execution progress of actions executed by one of server(s) 230 or computing device 430. For instance, FIG. 10 shows a flowchart 1000 for displaying an execution progress, according to an example embodiment. In an embodiment, flowchart 1000 may be implemented by incident handler UI 242 of computing device(s) 240, as shown in FIG. 2, and/or incident handler UI 446, as shown in FIG. 4. Other structural and operational embodiments will be apparent to persons skilled in the relevant art(s) based on the following discussion regarding flowchart 1000.

Flowchart 1000 begins with step 1002. In step 1002, a user interface is provided that displays the execution progress of the one or more suggested actions. For instance, with reference to FIG. 4, incident handler UI 446 may display a progress bar illustrating the progress of computing device 430 in automatically performing the actions selected by the user through incident handler UI 446. An execution progress may be displayed on the user interface as a percentage or as a graphical icon, or a combination of both. In an embodiment, the execution progress may illustrate the actual execution of each selected action performed by computing device 430, thereby permitting a user to view the automatic execution of each individual action in real-time. In this manner, a user may pause and/or undo the automatic execution, for instance, if the user desires to respond to the incident using a different set of actions. In another embodiment, providing a user interface displaying a real-time execution of the one or more suggested actions by action executor 448 permits the user to view any errors during the automatic execution as they arise.

In an embodiment, automated incident handler 132, automated incident handler 232, and/or automated incident handler 432 may orchestrate a set of suggested actions based on a similarity between a generated feature vector and feature vector(s) of previous incident reports. For instance, FIG. 11 shows a flowchart 1100 for enabling an automated handling of an information technology incident report based on a determined similarity to previous incident reports, according to an example embodiment. In an embodiment, flowchart 1100 may be implemented by automated incident handler 132, automated incident handler 232, and/or automated incident handler 432. Other structural and operational embodiments will be apparent to persons skilled in the relevant art(s) based on the following discussion regarding flowchart 1100.

Flowchart 1100 begins with step 1102. In step 1102, an incident report is received. In step 1104, a feature vector based on the incident report is generated. Steps 1102 and 1104 of FIG. 11 may be performed in a manner substantially similar as described above with reference to steps 302 and 304, respectively, of FIG. 3.

In step 1106, one or more suggested actions are automatically determined based on a similarity between the feature vector corresponding to the generated incident report and one or more feature vectors associated with previous incident reports. For instance, with reference to FIG. 4, action recommender 442 may receive an incident report from incident generator 436 and provide the incident report to featurizer 438 to obtain a feature vector corresponding to the incident report. Upon receiving the feature vector from featurizer 438, action recommender 442 may utilize a similarity metric (e.g., a cosine similarity metric although this is only one non-limiting example) to identify feature vectors associated with previous incident reports that are similar to the feature vector corresponding to the generated incident report. Action recommender 442 may then output one or more suggested actions to perform in response to the incident report, wherein the suggested actions are associated with the previous incident report(s) having similar feature vector(s). For example, if model 444 is unable to output one or more suggested actions based on a lack of learned behavior corresponding to the feature vector generated incident report, the action recommender 442 may nevertheless identify similar feature vectors for prior incident reports and then recommend actions taken in response to the prior incident reports to a user.

In step 1108, one or more suggested actions is output to a user. In step 1110, a user interface is provided that allows a user to select one or more of the suggested actions. In step 1112, at least one of the suggested actions is automatically executed. Steps 1108, 1110, and 1112 of FIG. 11 may be performed in a manner substantially similar as described above with reference to steps 308, 310, and 312, respectively, of FIG. 3.

It is noted that the above systems and methods are not intended to be limiting. Persons skilled in the relevant art(s) will understand that the all of the techniques described herein may be extended to automating any IT tasks. Furthermore, because the techniques may be extended to automating any IT tasks, persons skilled in the relevant art(s) will understand that the reports described herein can relate to any event occurring in a computing environment.

III. Example Mobile Device Implementation

FIG. 12 is a block diagram of an exemplary mobile device 1202 that may implement embodiments described herein. For example, mobile device 1202 may be used to implement any of computing devices 120A-120N or computing device(s) 130 described above in reference to FIG. 1, computing devices 220A-220N, server(s) 230, or computing device(s) 240 described above with reference to FIG. 2, or computing device 430 described above with reference to FIG. 4. As shown in FIG. 12, mobile device 1202 includes a variety of optional hardware and software components. Any component in mobile device 1202 can communicate with any other component, although not all connections are shown for ease of illustration. Mobile device 1202 can be any of a variety of computing devices (e.g., cell phone, smartphone, handheld computer, Personal Digital Assistant (PDA), etc.) and can allow wireless two-way communications with one or more mobile communications networks 1204, such as a cellular or satellite network, or with a local area or wide area network.

The illustrated mobile device 1202 can include a controller or processor 1210 (e.g., signal processor, microprocessor, ASIC, or other control and processing logic circuitry) for performing such tasks as signal coding, data processing, input/output processing, power control, and/or other functions. An operating system 1212 can control the allocation and usage of the components of mobile device 1202 and provide support for one or more application programs 1214 (also referred to as “applications” or “apps”). Application programs 1214 may include common mobile computing applications (e.g., digital personal assistants, e-mail applications, calendars, contact managers, web browsers, messaging applications) and any other computing applications (e.g., word processing applications, mapping applications, media player applications).

The illustrated mobile device 1202 can include memory 1220. Memory 1220 can include non-removable memory 1222 and/or removable memory 1224. Non-removable memory 1222 can include RAM, ROM, flash memory, a hard disk, or other well-known memory devices or technologies. Removable memory 1224 can include flash memory or a Subscriber Identity Module (SIM) card, which is well known in GSM communication systems, or other well-known memory devices or technologies, such as “smart cards.” Memory 1220 can be used for storing data and/or code for running operating system 1212 and applications 1214. Example data can include web pages, text, images, sound files, video data, or other data to be sent to and/or received from one or more network servers or other devices via one or more wired or wireless networks. Memory 1220 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

Mobile device 1202 can support one or more input devices 1230, such as a touch screen 1232, a microphone 1234, a camera 1236, a physical keyboard 1238 and/or a trackball 1240 and one or more output devices 1250, such as a speaker 1252 and a display 1254. Other possible output devices (not shown) can include piezoelectric or other haptic output devices. Some devices can serve more than one input/output function. For example, touch screen 1232 and display 1254 can be combined in a single input/output device. The input devices 1230 can include a Natural User Interface (NUI).

Wireless modem(s) 1260 can be coupled to antenna(s) (not shown) and can support two-way communications between the processor 1210 and external devices, as is well understood in the art. The modem(s) 1260 are shown generically and can include a cellular modem 1266 for communicating with the mobile communication network 1204 and/or other radio-based modems (e.g., Bluetooth 1264 and/or Wi-Fi 1262). At least one of the wireless modem(s) 1260 is typically configured for communication with one or more cellular networks, such as a GSM network for data and voice communications within a single cellular network, between cellular networks, or between the mobile device and a public switched telephone network (PSTN).

Mobile device 1202 can further include at least one input/output port 1280, a power supply 1282, a satellite navigation system receiver 1284, such as a Global Positioning System (GPS) receiver, an accelerometer 1286, and/or a physical connector 1290, which can be a USB port, IEEE 1394 (FireWire) port, and/or RS-232 port. The illustrated components of mobile device 1202 are not required or all-inclusive, as any components can be deleted and other components can be added as would be recognized by one skilled in the art.

In an embodiment, mobile device 1202 is configured to perform any of the functions of any of computing devices 120A-120N or computing device(s) 130 described above in reference to FIG. 1, computing devices 220A-220N, server(s) 230, or computing device(s) 240 described above with reference to FIG. 2, or computing device 430 described above with reference to FIG. 4. Computer program logic for performing the functions of these devices may be stored in memory 1220 and executed by processor 1210. By executing such computer program logic, processor 1210 may be caused to implement any of the features of any of these devices. Also, by executing such computer program logic, processor 1210 may be caused to perform any or all of the steps of flowcharts 300, 500, 600, 700, 800, 900, 1000, and 1100.

IV. Example Computer System Implementation

One or more of the components of computing devices 120A-120N or computing device(s) 130 described above in reference to FIG. 1, computing devices 220A-220N, server(s) 230, or computing device(s) 240 described above with reference to FIG. 2, or computing device 430 described above with reference to FIG. 4, and one or more steps of flowcharts 300, 500, 600, 700, 800, 900, 1000, and 1100 may be implemented in hardware, or hardware combined with software and/or firmware. For example, one or more of the components of computing devices 120A-120N or computing device(s) 130 described above in reference to FIG. 1, computing devices 220A-220N, server(s) 230, or computing device(s) 240 described above with reference to FIG. 2, or computing device 430 described above with reference to FIG. 4, and one or more steps of flowcharts 300, 500, 600, 700, 800, 900, 1000, and 1100 may be implemented as computer program code/instructions configured to be executed in one or more processors and stored in a computer readable storage medium.

In another embodiment, one or more of the components of computing devices 120A-120N or computing device(s) 130 described above in reference to FIG. 1, computing devices 220A-220N, server(s) 230, or computing device(s) 240 described above with reference to FIG. 2, or computing device 430 described above with reference to FIG. 4, and one or more steps of flowcharts 300, 500, 600, 700, 800, 900, 1000, and 1100 may also be implemented in hardware that operates software as a service (SaaS) or platform as a service (PaaS). Alternatively, one or more of the components of computing devices 120A-120N or computing device(s) 130 described above in reference to FIG. 1, computing devices 220A-220N, server(s) 230, or computing device(s) 240 described above with reference to FIG. 2, or computing device 430 described above with reference to FIG. 4, and one or more steps of flowcharts 300, 500, 600, 700, 800, 900, 1000, and 1100 may be implemented as hardware logic/electrical circuitry.

For instance, in an embodiment, one or more of the components of computing devices 120A-120N or computing device(s) 130 described above in reference to FIG. 1, computing devices 220A-220N, server(s) 230, or computing device(s) 240 described above with reference to FIG. 2, or computing device 430 described above with reference to FIG. 4, and one or more steps of flowcharts 300, 500, 600, 700, 800, 900, 1000, and 1100 may be implemented together in a system on a chip (SoC). The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

FIG. 13 depicts an exemplary implementation of a computing device 1300 in which embodiments may be implemented. For example, computing devices 120A-120N or computing device(s) 130 described above in reference to FIG. 1, computing devices 220A-220N, server(s) 230, or computing device(s) 240 described above with reference to FIG. 2, or computing device 430 described above with reference to FIG. 4 may each be implemented in one or more computing devices similar to computing device 1300 in stationary or mobile computer embodiments, including one or more features of computing device 1300 and/or alternative features. The description of computing device 1300 provided herein is provided for purposes of illustration, and is not intended to be limiting. Embodiments may be implemented in further types of computer systems, as would be known to persons skilled in the relevant art(s).

As shown in FIG. 13, computing device 1300 includes one or more processors, referred to as processor circuit 1302, a system memory 1304, and a bus 1306 that couples various system components including system memory 1304 to processor circuit 1302. Processor circuit 1302 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 1302 may execute program code stored in a computer readable medium, such as program code of operating system 1330, application programs 1332, other programs 1334, etc. Bus 1306 represents one or more of any of several types of bus structures, including a memory bus or memory controller, a peripheral bus, an accelerated graphics port, and a processor or local bus using any of a variety of bus architectures. System memory 1304 includes read only memory (ROM) 1308 and random access memory (RAM) 1310. A basic input/output system 1312 (BIOS) is stored in ROM 1308.

Computing device 1300 also has one or more of the following drives: a hard disk drive 1314 for reading from and writing to a hard disk, a magnetic disk drive 1316 for reading from or writing to a removable magnetic disk 1318, and an optical disk drive 1320 for reading from or writing to a removable optical disk 1322 such as a CD ROM, DVD ROM, or other optical media. Hard disk drive 1314, magnetic disk drive 1316, and optical disk drive 1320 are connected to bus 1306 by a hard disk drive interface 1324, a magnetic disk drive interface 1326, and an optical drive interface 1328, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 1330, one or more application programs 1332, other programs 1334, and program data 1336. Application programs 1332 or other programs 1334 may include, for example, computer program logic (e.g., computer program code or instructions) for implementing one or more of the components of computing devices 120A-120N or computing device(s) 130 described above in reference to FIG. 1, computing devices 220A-220N, server(s) 230, or computing device(s) 240 described above with reference to FIG. 2, or computing device 430 described above with reference to FIG. 4, and one or more steps of flowcharts 300, 500, 600, 700, 800, 900, 1000, and 1100, and/or further embodiments described herein.

A user may enter commands and information into the computing device 1300 through input devices such as keyboard 1338 and pointing device 1340. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 1302 through a serial port interface 1342 that is coupled to bus 1306, but may be connected by other interfaces, such as a parallel port, game port, or a universal serial bus (USB).

A display screen 1344 is also connected to bus 1306 via an interface, such as a video adapter 1346. Display screen 1344 may be external to, or incorporated in computing device 1300. Display screen 1344 may display information, as well as being a user interface for receiving user commands and/or other information (e.g., by touch, finger gestures, virtual keyboard, etc.). In addition to display screen 1344, computing device 1300 may include other peripheral output devices (not shown) such as speakers and printers.

Computing device 1300 is connected to a network 1348 (e.g., the Internet) through an adaptor or network interface 1350, a modem 1352, or other means for establishing communications over the network. Modem 1352, which may be internal or external, may be connected to bus 1306 via serial port interface 1342, as shown in FIG. 13, or may be connected to bus 1306 using another interface type, including a parallel interface.

As used herein, the terms “computer program medium,” “computer-readable medium,” and “computer-readable storage medium” are used to refer to physical hardware media such as the hard disk associated with hard disk drive 1314, removable magnetic disk 1318, removable optical disk 1322, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 1332 and other programs 1334) may be stored on the hard disk, magnetic disk, optical disk, ROM, RAM, or other hardware storage medium. Such computer programs may also be received via network interface 1350, serial port interface 1342, or any other interface type. Such computer programs, when executed or loaded by an application, enable computing device 1300 to implement features of embodiments discussed herein. Accordingly, such computer programs represent controllers of the computing device 1300.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

V. Additional Example Embodiments

A method for enabling automated handling of information technology tasks is described herein. The method includes: receiving a report, the report relating to an event occurring in a computing environment; generating a feature vector based on the report; providing the feature vector as input to a machine-learning-based model that outputs one or more suggested actions based on the feature vector, the machine-learning-based model being trained based on previous actions executed in relation to previous reports; providing a user interface that enables a user to select at least one of the one or more suggested actions; and in response to a user selection of at least one of the one or more suggested actions, automatically executing the at least one of the one or more suggested actions.

In one embodiment of the foregoing method, the method further comprises displaying at least one of a priority determination, a confidence value or a ranking regarding the one or more suggested actions.

In another embodiment of the foregoing method, the previous actions executed in relation to the previous reports are obtained at least in part by automatically logging one or more user actions executed in relation to at least one of the previous reports.

In another embodiment of the foregoing method, the previous actions executed in relation to the previous reports include actions executed by a plurality of users in relation to one of the previous reports.

In another embodiment of the foregoing method, the method further comprises displaying at least one value indicative of a number of times the one or more suggested actions were executed in relation to one or more previous reports.

In another embodiment of the foregoing method, the one or more suggested actions are personalized to the user.

In another embodiment of the foregoing method, at least one of the one or more suggested actions comprises an orchestrated sequence of actions.

A system is described herein. The system includes: a response logger implemented on at least one of the one more computing devices and configured to log one or more actions executed by at least one user in relation to one or more previously-generated reports; a model generator implemented on at least one of the one or more computing devices and configured to generate a model based on the logged actions for the one or more previously-generated reports; an action recommender implemented on at least one of the one or more computing devices and configured to apply the model to determine one or more suggested actions to execute in relation to a generated report relating to an event occurring in a computing environment; a user interface implemented on at least one of the one or more computing devices and configured to enable a user to select at least one of the one or more suggested actions for execution; and an action executor implemented on at least one of the one or more computing devices that, in response to a user selection of at least one of the one or more suggested actions, executes the at least one of the one or more suggested actions.

In one embodiment of the foregoing system, the user interface is further configured to display at least one of a priority determination, a confidence value or a ranking regarding the one or more suggested actions.

In another embodiment of the foregoing system, the user interface is further configured to display an execution progress of the least one of the one or more suggested actions.

In another embodiment of the foregoing system, the one or more suggested actions are based, at least in part, on logged actions executed by a plurality of users for one or more previously-generated reports.

In another embodiment of the foregoing system, the user interface is further configured to display at least one value indicative of a number of times the one or more suggested actions were executed in relation to one or more previously-generated reports.

In another embodiment of the foregoing system, the one or more suggested actions are personalized to the user.

In another embodiment of the foregoing system, at least one of the one or more suggested actions comprises an orchestrated sequence of actions.

A method for enabling automated handling of information technology tasks is described herein. The method includes: receiving a report, the report relating to an event occurring in a computing environment; generating a feature vector based on the report; automatically determining one or more suggested actions based on a measure of similarity between the feature vector and one or more feature vectors respectively associated with one or more previous reports; providing a user interface that enables a user to select at least one of the one or more suggested actions; and in response to a user selection of at least one of the one or more suggested actions, automatically executing the at least one of the one or more suggested actions.

In one embodiment of the foregoing method, the method further comprises displaying at least one of a priority determination, a confidence value or a ranking regarding the one or more suggested actions.

In another embodiment of the foregoing method, the providing the user interface comprises displaying an execution progress of the at least one of the one or more suggested actions.

In another embodiment of the foregoing method, the one or more suggested actions are based, at least in part, on actions executed by more than one user for the one or more previous reports.

In another embodiment of the foregoing method, the one or more suggested actions are personalized to the user.

In another embodiment of the foregoing method, the providing the user interface comprises enabling the user to choose a subset of the one or more suggested actions.

VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for enabling automated handling of information technology tasks, the method comprising:
receiving a report, the report relating to an event occurring in a computing environment;
generating a feature vector based on the report;
providing the feature vector as input to a machine-learning-based model that outputs one or more suggested actions based on the feature vector, the machine-learning-based model being trained based on previous actions executed in relation to previous reports;
providing a user interface that enables a user to select at least one of the one or more suggested actions; and
in response to a user selection of at least one of the one or more suggested actions, automatically executing the at least one of the one or more suggested actions.

2. The method of claim 1, further comprising:
displaying at least one of a priority determination, a confidence value or a ranking regarding the one or more suggested actions.

3. The method of claim 1, wherein the previous actions executed in relation to the previous reports are obtained at least in part by automatically logging one or more user actions executed in relation to at least one of the previous reports.

4. The method of claim 1, wherein the previous actions executed in relation to the previous reports include actions executed by a plurality of users in relation to one of the previous reports.

5. The method of claim 1, further comprising:
displaying at least one value indicative of a number of times the one or more suggested actions were executed in relation to one or more previous reports.

6. The method of claim 1, wherein the one or more suggested actions are personalized to the user.

7. The method of claim 1, wherein the at least one of the one or more suggested actions comprises an orchestrated sequence of actions.

8. A system implemented by one or more computing devices, the system comprising:
a response logger implemented on at least one of the one more computing devices and configured to log one or more actions executed by at least one user in relation to one or more previously-generated reports;
a model generator implemented on at least one of the one or more computing devices and configured to generate a model based on the logged actions for the one or more previously-generated reports;
an action recommender implemented on at least one of the one or more computing devices and configured to apply the model to determine one or more suggested actions to execute in relation to a generated report relating to an event occurring in a computing environment;
a user interface implemented on at least one of the one or more computing devices and configured to enable a user to select at least one of the one or more suggested actions for execution; and
an action executor implemented on at least one of the one or more computing devices that, in response to a user selection of at least one of the one or more suggested actions, executes the at least one of the one or more suggested actions.

9. The system of claim 8, wherein the user interface is further configured to display at least one of a priority determination, a confidence value or a ranking regarding the one or more suggested actions.

10. The system of claim 8, wherein the user interface is further configured to display an execution progress of the least one of the one or more suggested actions.

11. The system of claim 8, wherein the one or more suggested actions are based, at least in part, on logged actions executed by a plurality of users for one or more previously-generated reports.

12. The system of claim 8, wherein the user interface is further configured to display at least one value indicative of a number of times the one or more suggested actions were executed in relation to one or more previously-generated reports.

13. The system of claim 8, wherein the one or more suggested actions are personalized to the user.

14. The system of claim 8, wherein the at least one of the one or more suggested actions comprises an orchestrated sequence of actions.

15. A method for enabling automated handling of information technology tasks comprising:
receiving a report, the report relating to an event occurring in a computing environment;
generating a feature vector based on the report;
automatically determining one or more suggested actions based on a measure of similarity between the feature vector and one or more feature vectors respectively associated with one or more previous reports;
providing a user interface that enables a user to select at least one of the one or more suggested actions; and
in response to a user selection of at least one of the one or more suggested actions, automatically executing the at least one of the one or more suggested actions.

16. The method of claim 15, further comprising:
displaying at least one of a priority determination, a confidence value or a ranking regarding the one or more suggested actions.

17. The method of claim 15, wherein the providing the user interface comprises displaying an execution progress of the at least one of the one or more suggested actions.

18. The method of claim 15, wherein the one or more suggested actions are based, at least in part, on actions executed by more than one user for the one or more previous reports.

19. The method of claim 15, wherein the one or more suggested actions are personalized to the user.

20. The method of claim 15, wherein the providing the user interface comprises enabling the user to choose a subset of the one or more suggested actions.
